(19) United States
(12) Patent Application Publication
(10) Pub. No.: US 2008/0051520 A1
(43) Pub. Date: Feb. 28, 2008

(54) ALKYL ACRYLATE COPOLYMER VI MODIFIERS AND USES THEREOF

(75) Inventors: Sanjay Srinivasan, Midlothian, VA (US); John T. Loper, Richmond, VA (US); Naresh C. Mathur, Midlothian, VA (US); Akhilesh Duggal, Midlothian, VA (US)

Correspondence Address: FITCH, EVEN, TABIN & FLANNERY, P.O. BOX 18415, WASHINGTON, DC, 20036, US

(73) Assignee: AFTON CHEMICAL CORPORATION, Richmond, VA (US)

(21) Appl. No.: 11/853,424

(22) Filed: Sep. 11, 2007

Related U.S. Application Data
(62) Division of application No. 11/494,524, filed on Jul. 28, 2006.

(51) Int. Cl. C08F 34/02; C08F 8/32

(52) U.S. Cl. 525/382; 525/379; 526/271; 526/317.1; 526/318.2

(57) ABSTRACT

A novel a multi-functional polymer viscosity modifier comprising an additive reaction product obtained by reacting a first monomer comprising an alkylacrylate with a second monomer comprising an olefinic carboxylic acylating agent under conditions effective for free radical polymerization of the first and second monomers to provide a base polymer comprising an acylated alkylacrylate copolymer, and wherein the base polymer optionally may be further reacted with an amine compound to provide a multi-functional polyalkylacrylate copolymer. The base polymer has good thickening efficiency. The multi-functional polyalkylacrylate copolymer dispersant viscosity modifier has good thickening efficiency. The base polymer and the multi-functional polyalkylacrylate copolymer viscosity modifier have good thickening efficiency, low temperature properties, dispersancy, and antioxidancy properties. They also have no precipitation or sedimentation, nor cause or encourage such formations in finished fluids incorporating them.

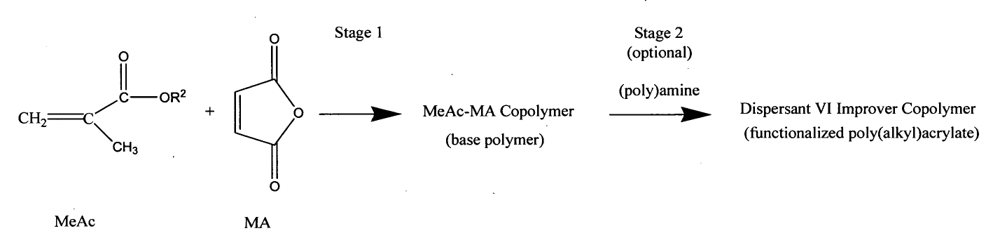

### TECHNICAL FIELD

This invention relates to a lubricant additive useful as an improved multifunctional dispersant viscosity index improver when employed in a lubricating oil composition.

### BACKGROUND OF THE INVENTION

Polymethacrylate viscosity index improvers (PMA VII's) are generally known in the lubricating industry. Attempts have been made to produce PMA VII's that have a desirable balance of high temperature and low temperature viscometrics, as well as the required shear stability for a given application. Obtaining suitable low temperature performance has become even more difficult with the movement away from API Group I base oils and the increased utilization of Group II and Group III base oils. Further, refiners who blend with different base oils ideally would have a single product which performs effectively in all of these different base oils.

Acrylate-based chemistries have been used as pour point depressants such as described in U.K. Patent No. 1,559,952. U.S. Pat. No. 4,867,894, U.S. Pat. No. 5,312,884. EP 0 236 844 B1. U.S. Pat. No. 6,255,261 B1 describes polyalkyl(meth)acrylate copolymers having excellent low temperature properties, and their use as pour point depressants for lubricating oils. The polyalkyl(meth)acrylate copolymers comprise units derived from about 5 to about 60 weight percent of a C11-C15 alkyl(meth)acrylate and from about 95 to about 40 weight percent of a C16-C30 alkyl(meth)acrylate U.S. Pat. No. 4,146,492 discloses lubricating oil compositions comprising between about 0.5 and 30 wt. % of a specifically defined ethylene-propylene copolymer and between about 0.005 to 10 wt. % of a neat interpolymeric polyalkylacrylate of (A) C1-C15 alkylacrylate and (B) C16-C22 alkylacrylate having a weight ratio of A:B of between about 90:10 and 50:50, a molecular weight of from 1000 to 25,000 and an average alkyl side chain length of between about 11 and 16 carbons.

### SUMMARY OF THE INVENTION

The present invention is directed to novel polyalkylacrylate copolymers comprising the additive reaction product prepared by reacting i) a first set of monomers comprising alkyl acrylates comprising three different subgroups including a first subgroup of alkyl acrylates wherein the alkyl group has 1 to 4 carbon atoms, a second subgroup thereof wherein the alkyl group has 8 to 16 carbon atoms, and a third subgroup wherein the alkyl group has 17 to 30 carbon atoms, with ii) a second monomer comprising an olefinic carboxylic acylating agent under conditions effective for free radical polymerization of the first and second monomers to provide a base polymer comprising an acylated alkyl acrylate copolymer, which is optionally further reacted with an amine compound to provide a functionalized polyalkylacrylate copolymer viscosity modifier.

The base polymer is a stable compound, which may be stored and handled before being further functionalized. Also, it does not necessarily need to be further functionalized to be ready-for-use itself as a beneficial lubricant additive, depending on the particular application. The functionalized polyalkylacrylate copolymer viscosity modifier is an enhanced form of the novel base polymer (i.e., the non-aminated copolymer).

Among other advantages, the base polymer and the functionalized polyalkylacrylate copolymer viscosity modifiers made according to the present invention have good thickening efficiency, low temperature properties, dispersancy, and/or antioxidancy properties. They also have no precipitation or sedimentation, nor cause or encourage such formations in finished fluids incorporating them. They are polymer bound antioxidants having potential in enhancing the oxidative stability and dispersancy of lubricants which are limited by the thermal and oxidative stability of conventional lower molecular weight antioxidants. They also may be used in engine oil applications to improve or boost oxidation, dispersancy, high temperature high shear (HTHS)/fuel economy, and low temperature viscometrics (e.g., cold cranking simulator (CCS) and mini-rotary viscometer (MRV) properties) in conjunction with conventional succinimides and at a lower olefin copolymer (OCP) loading in the finished oil. Particularly, they exhibit outstanding low temperature properties in lubricating oils for applications such as crankcase lubricants and automatic transmission fluids. They exhibit excellent low temperature performance in a wide variety of base oils. They also provide good VII performance in lubricant compositions that entirely omit or contain relatively low amounts of ethylene-propylene polymer VI modifiers.

As a reactant in the copolymerization reaction used for synthesizing the base polymer, the first set of monomers comprises three subgroups of alkyl(alkyl)acrylate monomers having general structure 1a: 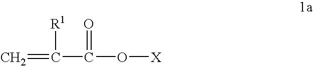
wherein R¹ may be hydrogen or alkyl, and X represents a non-substituted or substituted n-alkyl group with the proviso that the alkyl acrylate monomer reactant includes a first subgroup of alkyl(alkyl)acrylates where X is an alkyl group having 1 to 7 carbon atoms and preferably 1 to 4 carbon atoms (i.e., the “short” chain length group), a second subgroup where X has 8 to 16 carbon atoms (i.e., the “medium” chain length group), and a third subgroup where X has 17 to 30 carbon atoms (i.e., the “long” chain length group). The gravimetric ratio of the three subgroups, i.e., short/medium/long, of alkyl acrylate monomers used in the copolymerization reaction may range from about 5:95:0.05 to about 35:55:10, respectively. Substituted alkyl groups may include, e.g., an epoxy functional alkyl group, a keto functional alkyl group, or an aminoalkyl group.

In a particular embodiment, the first monomer comprises three subgroups of alkyl(alkyl)acrylates having general structure 2a: 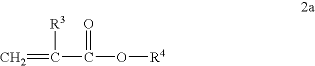
where R³ is hydrogen or a C1-C5 alkyl group, and R⁴ is a non-substituted or substituted C1-C30 alkyl group with the proviso that the alkyl acrylate monomer reactant includes three different subgroups comprising a first subgroup of alkyl(alkyl)acrylates in which R⁴ has 1 to 4 carbon atoms, a second subgroup thereof in which R¹ has 8 to 16 carbon atoms and a third subgroup thereof in which R⁴ has 17 to 30 carbon atoms. For purposes herein, the term “alkyl(alkyl)acrylate” generally refers to esters of alkyl(alkyl)acrylic acids and/or the precursor acids per se, which may be further defined or qualified within a particular context herein.

The second monomer may comprise an unsaturated monocarboxylic acid anhydride, an unsaturated dicarboxylic acid anhydride, or corresponding acid thereof, which may be selected, for example, from the group consisting of maleic anhydride, itaconic anhydride, halomaleic anhydride, alkylmaleic anhydride, maleic acid, and fumaric acid, and combinations and derivatives thereof. Suitable second monomers particularly may include unsaturated dicarboxylic acid anhydrides and their corresponding acids, more particularly those having the general formula A1, B1, C1 or D1: 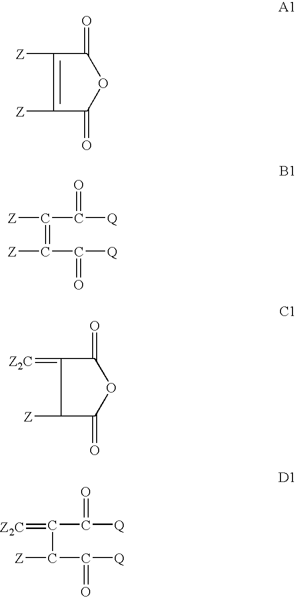
wherein Z is preferably hydrogen but may also be an organic group such as a branched or straight chain alkyl group, an anhydride, a ketone group, a heterocyclic group or other organic group containing 1-12 carbon atoms. In addition, Z can be a halogen such as chlorine, bromine or iodine. Q can be OH or an alkoxy group containing 1-8 carbon atoms. Maleic anhydride and itaconic anhydride, and/or their corresponding acids, are particularly suitable.

The base polymer may comprise monomeric units derived from about 99.9 to about 80 weight percent of alkyl acrylate monomers and about 0.1 to about 20 weight percent olefinic acylating agent monomers. For VII applications, it is preferred that the base polymer has a number average molecular weight between about 50,000 to about 1,000,000, more preferably about 50,000 to about 500,000, as determined by gel permeation chromatography.

As to the amine functionalization of the base polymer, the amine compound reactant may comprise, e.g., an aromatic amine compound or an aliphatic amine compound. The aromatic amine compound may comprise, e.g., an N-aryl or N-alkyl substituted phenylene diamine. N-aryl substituted phenylene diamines may include substituted N-arylphenylene diamines, and 4,4′-diaminodiphenylamine, or salts thereof. The aliphatic amine compound may comprise a polyalkylenepolyamine compound or other polyamines.

In one particular embodiment, C1-C30 alkylmethacrylate monomers are reacted with maleic anhydride monomers (1-10 wt. %) in presence of a free radical initiator to yield a maleated polymethacrylate copolymer intermediate, which is subsequently functionalized with a polyamine compound to provide a functionalized dispersant/antioxidant polymethacrylate suitable for use, e.g., in lubricating fluid compositions such as engine oils, automatic transmission fluids, gear oils, industrial, metalworking and hydraulic fluids.

Such an amine-functionalized polyalkylacrylates may have a number average molecular weight between about 50,000 to about 1,000,000. At lower molecular weights, the amine polymer may not be sufficiently effective in VII applications.

In one non-limiting embodiment, the base polymer (I), and a functionalized polyalkylacrylate copolymer dispersant (IIa+IIb) having a number average molecular weight between about 50,000 to about 1,000,000 made with the base polymer, have the following respective structures: 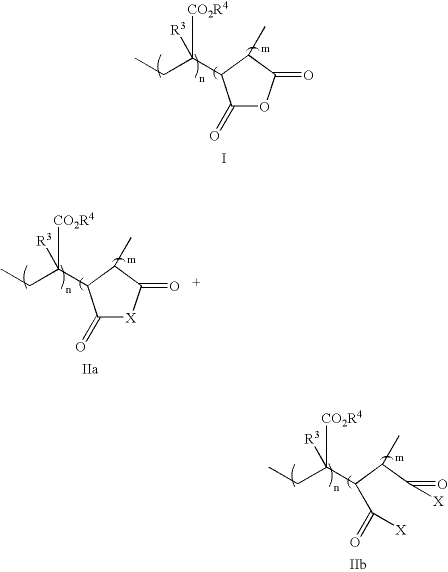
where for structures I, IIa, and IIb, m is defined as ranging from 0.1% to 20% of the value of n, wherein the sum of m and n is between 50,000 and about 1,000,000, X represents a moiety derived from the functionalizing amine bonded to the molecule through the nitrogen of an amine group, R³ and R⁴ represent the same groups as defined hereinabove. In a particular embodiment, X is derived from a functionalizing amine having the structure: R′R″(NR), NR′″ R″″, wherein R, R′, R″, R′″, R″″ are independently H, alkyl, alkaryl, aralkyl, cycloalkyl, or aryl hydrocarbon and R is alkylene, aralkylene, cycloalkylene, alkarylene, or arylene, and a is 0-20. The dispersant product typically is obtained as a physical combination of compounds of structures IIa and IIb.

Novel lubricant compositions of the present invention also are provided comprising an oil of lubricating viscosity and an effective amount of the multi-functional polyalkylacrylate copolymer reaction product (viz., the additive reaction product), in the form of additive concentrates or finished lubricants. These lubricant compositions can be used to lubricate internal combustion engines, engine transmissions, gears and other mechanical devices and components. The additive reaction products of the present invention can effectively extend the service time available between oil drains in a vehicle having an engine lubricated with a lubrication composition containing the additive reaction products, among other benefits and advantages. The invention is also directed to engines lubricated with these improved lubricating compositions and compounds.

It is to be understood that both the foregoing general description and the following detailed description and FIGURE referenced therein are exemplary and explanatory only and are intended to provide further explanation of the present invention, as claimed.

### BRIEF DESCRIPTION OF DRAWING

The sole FIGURE shows a reaction scheme for preparing copolymer (base polymer) and functionalized copolymer products in accordance with a non-limiting illustration of the present invention.

### DETAILED DESCRIPTION OF THE PREFERRED EMBODIMENTS

A novel functionalized polyalkylacrylate copolymer is the reaction product of a method comprising copolymerizing a set of alkyl acrylate monomers comprised of three subgroups of alkyl acrylates having respective short, medium and long alkyl chain lengths as prescribed herein with an olefinic carboxylic acid acylating agent in the presence of a free radical initiator to provide a base polymer comprising an acylated alkylacrylate copolymer, which is further reacted with an amine compound to provide a multi-functional polyalkylacrylate copolymer viscosity modifier. The base polymer per se also represents a novel compound useful as a lubricant additive.

The base polymer or the functionalized polyalkylacrylate copolymer product can be diluted in an oil of lubricating viscosity to provide a lubricant. It may be beneficially used directly, or alternatively as pre-diluted in base oil in concentrate form, as an additive for lubricants. The base polymer may be used alone as a viscosity index (VI) modifier. The functionalized polyalkylacrylate copolymer product may be used in lubrication compositions for one or more functions including as a dispersant viscosity index (VI) modifier, antioxidant, film formation improver, deposit controller, as well as other functions. The multi-functional polyalkylacrylate copolymer also provides good VII performance in lubricating compositions that entirely omit or contain relatively low amounts of ethylene-propylene polymer VI modifiers.

1. Preparation of Base Polymer

First Set of Monomers

Referring to the sole FIGURE, an exemplary reaction scheme is illustrated for preparing base polymer and functionalized copolymer products in accordance with a non-limiting example of the present invention. As illustrated therein, in an initial stage of processing (“Stage 1”) of the reaction scheme, methacrylate (MeAc) and maleic anhydride (MA) are copolymerized to form a base polymer, illustrated here as a polymethacrylate-maleic anhydride copolymer (MeAc-MA Copolymer). It will be appreciated from the following descriptions that the invention has broader application than the exemplary illustration of the FIGURE. The base polymer is a stable compound, which may be stored and handled before being further functionalized. Also, it does not necessarily need to be further functionalized to be ready-for-use itself as a beneficial lubricant additive, depending on the particular application.

More generally, as a reactant in the copolymerization reaction used for synthesizing the base polymer (e.g., Stage 1), a first set of monomers may comprise acrylates or their acids having general structure 1a: 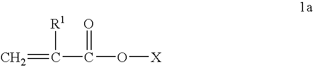
wherein R¹ may be hydrogen or alkyl, and X represents alkyl, or Y, where Y has general structure 1: 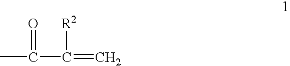
where R² may be hydrogen or alkyl. In a particular embodiment, general structure 1a represents an alkyl(alkyl)acrylate in which X represents a non-substituted or substituted n-alkyl group with the proviso that the alkyl acrylate monomer reactant include a first subgroup of alkyl(alkyl)acrylates having 1 to 7 carbon atoms and preferably 1 to 4 carbon atoms in the terminal alkyl group X (i.e., the “short” chain length group), a second subgroup thereof having 8 to 16 carbon atoms in alkyl group X (i.e., the “medium” chain length group), and a third subgroup thereof having 17 to 30 carbon atoms in alkyl group X (i.e., the “long” chain length group). The gravimetric ratio (i.e., a wt:wt:wt percentage basis) of the three subgroups, i.e., short/medium/long, of alkyl acrylate monomers (“AAM's”) used in the copolymerization reaction may range from about 5:95:0.05 to about 35:55:10, respectively. That is, generally about 5 to about 35 wt % short chain AAMs, about 95 to about 55 medium chain AAM's, and about 0.05 to about 10 wt % long chain AAM's may be used as the reactant monomers in the copolymerization reaction.

Substituted alkyl groups may include, e.g., an epoxy functional alkyl group, a keto functional alkyl group, or an aminoalkyl group.

In an alternative embodiment, general structure 1a represents an acrylate in which X represents Y having general structure 1 as defined above.

In a particular embodiment, such as exemplified in the sole FIGURE, the first monomer comprises three subgroups of alkyl(alkyl)acrylates having general structure 2a: 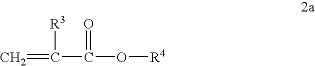
where R³ is hydrogen or a C1-C5 alkyl group, and R⁴ is a non-substituted or substituted C1-C30 alkyl group with the proviso that the alkyl(alkyl)acrylate monomer reactant includes three different subgroups comprising a first subgroup of alkyl(alkyl)acrylates in which R⁴ is an alkyl group having 1 to 4 carbon atoms, a second subgroup in which R⁴ is an alkyl group having 8 to 16 carbon atoms, and a third subgroup in which R⁴ is an alkyl group having 17 to 30 carbon atoms.

As indicated, the term “alkyl(alkyl)acrylate”, as used herein, generally refers to esters of alkyl(alkyl)acrylic acids and/or the precursor acids themselves, such as those having structure (1a), which may or may not be further defined or qualified within a particular context herein. In one embodiment, the alkyl(alkyl)acrylate may comprise C1-C30 alkyl(meth)acrylate, where the “C1-C30 alkyl” portion of the named compound corresponds to R⁴ in above general structure 2a. This alkyl(meth)acrylate is an alkyl ester of acrylic or methacrylic acid having a straight or branched alkyl group of 1 to 30 carbon atoms per group. In this regard, and with reference to structure 2a, the terminology “alkyl(alkyl)acrylate” occasionally may be applied herein for sake of convenience to more specifically identify the R⁴ group (corresponding to the first-mentioned alkyl group) as well as the R³ group (corresponding to the second-mentioned alkyl group) portions of the named acrylate compound.

Non-limiting examples of the first monomer include, e.g., methyl(meth)acrylate, ethyl (meth)acrylate, propyl(meth)acrylate, butyl(meth)acrylate, pentyl(meth)acrylate, hexyl (meth)acrylate, heptyl(meth)acrylate, octyl(meth)acrylate, nonyl(meth)acrylate, decyl (meth)acrylate, undecyl(meth)acrylate, lauryl(meth)acrylate, myristyl(meth)acrylate, dodecyl pentadecyl methacrylate, stearyl(meth)acrylate, cetyl(meth)acrylate, heptadecyl(meth)acrylate, nonadecyl(meth) acrylate, eicosyl(meth) acrylate, heneicosyl methacrylate, docosyl methacrylate, glycidyl(meth)acrylate, and aminopropyl(meth)acrylate, and blends, mixtures and combinations thereof. The first monomer also may have structure 2: 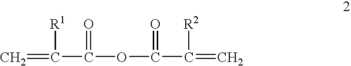
where R¹ and R² have the same meanings as described above.

The alkyl(meth)acrylate monomers generally may be prepared by standard esterification procedures using technical grades of aliphatic alcohols. Individual alkyl(meth) acrylates or mixtures thereof may be used. Those skilled in the art will appreciate that minor levels of other monomers, polymerizable with the alkyl(meth)acrylates disclosed herein, may be present as long as they do not adversely affect the low temperature properties of the fully formulated fluids, for example, increasing the low temperature pumping viscosity of a lubricating fluid when the pour point depressant is used in combination with a dispersant VI improver. Typically additional monomers are present in an amount of less than about 5 weight percent, preferably in an amount of less than 3 weight percent, most preferably in an amount of less than 1 weight percent. For example, the addition of minor levels of monomers such as nitrogen-containing alkyl(meth) acrylates, hydroxy- or alkoxy-containing alkyl(meth)acrylates, ethylene, propylene, styrene, vinyl acetate and the like are contemplated within the scope of this invention as long as the presence of these monomers do not materially increase the polarity of the copolymers.

Second Set of Monomers

As shown in the sole FIGURE, the alkylacrylate monomers are reacted with a second set of monomers, illustrated therein in a non-limiting manner as maleic anhydride (MA). The second set of monomers generally may include an unsaturated monocarboxylic acid anhydride, an unsaturated dicarboxylic acid anhydride, or corresponding acid thereof. Suitable second monomers particularly may include unsaturated dicarboxylic acid anhydrides and their corresponding acids, more particularly those having the general formula A1, B1, C1 or D1: 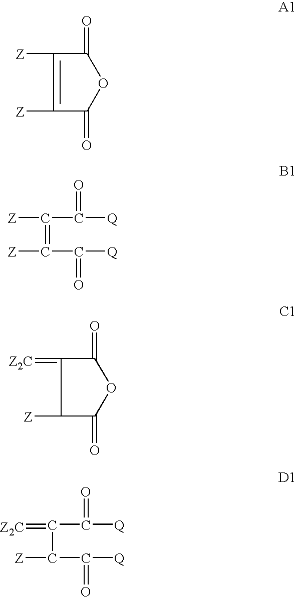
wherein Z is preferably hydrogen but may also be an organic group such as a branched or straight chain alkyl group, an anhydride, a ketone group, a heterocyclic group or other organic group containing 1-12 carbon atoms. In addition, Z can be a halogen such as chlorine, bromine or iodine. Q can be OH or an alkoxy group containing 1-8 carbon atoms.

Suitable second set monomers may be selected, for example, from the group consisting of maleic anhydride itaconic anhydride, halomaleic anhydride, alkylmaleic anhydride, maleic acid, and fumaric acid, and combinations and derivatives thereof. Examples of these monomers are set forth, for example, in U.S. Pat. No. 5,837,773, which descriptions are incorporated herein by reference. Maleic anhydride or a derivative thereof is generally most preferred due to its commercial availability and ease of reaction. In the case of unsaturated ethylene copolymers or terpolymers, itaconic acid or its anhydride is preferred due to its reduced tendency to form a cross-linked structure during the free-radical copolymerization process. The ethylenically unsaturated carboxylic acid materials typically can provide one or two carboxylic groups per mole of reactant to the polymer.

Free-Radical Initiator

The reaction to form the base polymer, i.e., acylated acrylate intermediates, in “Stage 1” shown in the FIGURE is generally carried out with the aid of a free-radical initiator. The free-radical initiators which may be used include, for example, peroxides, hydroperoxides, peresters, and also azo compounds and preferably those which have a boiling point greater than 100° C. and decompose thermally within the polymerization reaction temperature range to provide free radicals. Representatives of these free-radical initiators are benzoyl peroxide, 1-butyl perbenzoate, t-butyl peroctoate, cumen hydroperoxide, azoisobutyronitrile, 2,2′-azosbis(2-methylbutanenitrile), 2,5-dimethylhexane-2,5-bis-tertiarybutyl peroxide, and 2,5-dimethylhex-3-yne-2,5-bis-tertiary-butyl peroxide, etc. The initiator is used in an amount of between about 0.005% and about 1% by weight based on the weight of the reaction mixture.

Suitable chain transfer agents may also be included, e.g., mercaptans (thiols) such as lauryl mercaptan, dodecyl mercaptan, ethyl mercaptan, etc. The selection of the amount of chain transfer agent to be used is based on the desired molecular weight of the polymer being synthesized as well as the desired level of shear stability for the polymer, i.e., if a more shear stable polymer is desired, more chain transfer agent can be added to the reaction mixture.

Particularly, the chain transfer agent is added to the reaction mixture in an amount of 0.01 to 3 weight percent, more particularly 0.02 to 2.5 weight percent, relative to the monomer mixture.

The molecular weight of the base polymer product can be manipulated by adjusting the addition levels of the free-radical initiator and chain transfer agents. In general, all other variables equal, the use of increasing levels of free-radical initiator and chain transfer agents reduces the molecular weight of the resulting base polymer product, while decreasing levels thereof has the opposite effect on prodluct's molecular weight.

Copolymerization Reaction Equipment and Conditions

In order to prepare the base polymer (i.e., the acylated alkylacrylate copolymer) of the present invention, polymerization of the alkylacrylate monomers and an olefinic carboxylic acid acylating agent can take place under a variety of conditions, including bulk polymerization, solution polymerization, usually in an organic solvent, preferably mineral oil, emulsion polymerization, suspension polymerization and nonaqueous dispersion techniques. This reaction can be conducted either in a batch or continuous operation. It can be performed neat or in solution in a continuous flow or batch reactor equipped with intensive mixing capability. It also can be performed in an extruder or similar continuous intensive mixing device. Solution polymerization is preferred. In the solution polymerization, a reaction mixture comprising a diluent, the alkylacrylate monomer, the olefinic carboxylic acid acylating agent monomer, and a polymerization initiator is prepared.

The diluent may be any inert hydrocarbon and is preferably a hydrocarbon lubricating oil that is compatible with or identical to the lubricating oil in which the copolymer is to be subsequently used. The reaction mixture may includes, e.g. from about 15 to about 400 parts by weight (pbw) diluent per 100 pbw total monomers and, more preferably, from about 50 to about 200 pbw diluent per 100 pbw total monomers. As used herein. “total monomer charge” means the combined amount of all monomers in the initial, i.e., unreacted reaction mixture.

In preparing the base polymer (copolymer intermediates) of the present invention by free-radical polymerization the monomers may be polymerized simultaneously or sequentially, in any order. The base polymer may comprise monomeric units derived from about 99.9 to about 80 weight percent of alkylacrylate monomers and about 0.1 to about 20 weight percent olefinic acylating agent monomers. In a particular embodiment, the total monomer charge includes from 80 to 99.9 weight percent, preferably 90 to 99 weight percent, C1-C30 alkyl(meth)acrylate; and 0.1 to 20 weight percent, preferably 1 to 10 weight percent, maleic anhydride. Suitable polymerization initiators include initiators which disassociate upon heating to yield a free radical, e.g., peroxide compounds such as benzoyl peroxide, t-butyl perbenzoate, t-butyl peroctoate and cumene hydroperoxide; and azo compounds such as azoisobutyronitrile and 2,2′ azobis(2-methylbutanenitrile). The mixture includes from about 0.01 wt % to about 1.0 wt % initiator relative to the total monomer mixture. The copolymer synthesis reaction is conducted in an oil suitable for providing a polymerization medium, such as mineral or other base oil.

By way of example and without limitation, the reaction mixture may be charged to a reaction vessel that is equipped with a stirrer, a thermometer and a reflux condenser and heated with stirring under a nitrogen blanket to a temperature from about 50° C. to about 125° C. for a period of about 0.5 hours to about 6 hours to carry out the polymerization reaction. In a further embodiment, a portion, e.g., about 25 to 60% of the reaction mixture is initially charged to the reaction vessel and heated. The remaining portion of the reaction mixture is then metered into the reaction vessel, with stirring and while maintaining the temperature or the batch within the above describe range, over a period of about 0.5 hours to about 3 hours. A viscous solution of the copolymer of the present invention in the diluent is obtained as the product of the above-described process.

The processing equipment is generally purged with nitrogen to prevent oxidation of the polymer and to aid in venting unreacted reagents and byproducts of the polymerization reaction. The residence time in the processing equipment is controlled to provide for the desired degree of polymerization and to allow for purification of the base polymer product via venting-Mineral or synthetic lubricating oil may optionally be added to the processing equipment after the venting stage to dissolve the base polymer product.

The base polymer obtained may have a number average molecular weight between about 1,000 to about 1,000,000, as determined by gel permeation chromatography. For VII applications, it is preferred that the base polymer is prepared to have a number average molecular weight between about 50,000 to about 1,000,000, more preferably about 50,000 to about 500,000, and even more preferably abut 100,000 to about 500,000. The base polymer may have a weighted average molecular weight between about 100,000 to about 1,000,000, more preferably about 200,000 to about 1,000,000

Vacuum Stripping of Unreacted Ingredients

Upon completion of the copolymerization reaction (“Stage 1”), unreacted carboxylic reactant and free radical initiator may be optionally removed and separated from the base polymer before further functionalization is performed on the base polymer. The unreacted components may be eliminated from the reaction mass by vacuum stripping, e.g., the reaction mass may be heated to temperature up to about 250° C. under agitation with a vacuum applied for a period sufficient to remove the volatile unreacted monomer and free radical initiator ingredients.

Amination of Base Polymer

Referring again to the FIGURE, in the optional second stage of processing (“Stage 2”), the base polymer possessing carboxylic acid acylating functions is reacted with an amine compound. As indicated, the base polymer per se is a functional lubricant additive, and amination is an optional enhancement thereon. The amine compound may be, for example, an aromatic amine or aliphatic amine, or a combination thereof. The amine compound may be selected from aromatic amine compounds such as described, e.g., in U.S. Pat. Nos. 4,863,623, 5,075,383, and 6,107,257, which descriptions are incorporated herein by reference. In one embodiment, the amine compound may be, e.g., an N-arylphenylenediamine represented by the general formula: 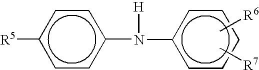
in which R⁵ is hydrogen, —NH₂, —NH-aryl, —NH-arylalkyl, —NH-alkyl, or a branched or straight chain radical having from 4 to 24 carbon atoms that can be alkyl, alkenyl, alkoxyl, aralkyl, alkaryl, hydroxyalkyl or aminoalkyl; R⁶ is —NH₂, CH₂—(CH₂)ₙ—NH₂, CH₂-aryl-NH₂, in which n has a value from 1 to 10 and R⁷ is hydrogen, alkyl, alkenyl, alkoxyl, aralkyl, alkaryl having from 4 to 24 carbon atoms. Particular aromatic amines for use in the present invention are the N-arylphenylenediamines, more specifically the N-phenylphenylenediamines, for example, N-phenyl-1,4-phenylenediamine, N-phenyl-1,3-phenylenediamine, N-phenyl-1,2-phenylenediamine, and 4,4-diaminodiphenylamine, or salts thereof.

The aromatic amine can also be an amine comprising two linked aromatic moieties. By the term “aromatic moiety is meant to include both mononuclear and polynuclear groups. The polynuclear groups can be of the fused type wherein an aromatic nucleus is fused at two points to another nucleus such as found in naphthyl or anthranyl groups. The polynuclear group can also be of the linked type wherein at least two nuclei (either mononuclear or polynuclear) are linked through bridging linkages to each other. These bridging linkages can be chosen from, among others known to those skilled in the art, alkylene linkages, ether linkages, ester linkages, keto linkages, sulfide linkages, polysulfide linkages of 2 to 6 sulfur atoms, sulfone linkages, sulfonamide linkages, amide linkages, azo linkages, and direct carbon-carbon linkages between the groups without any intervening atoms. Other aromatic groups include those with heteroatoms, such as pyridine, pyrazine, pyrimidine, and thiophene. Examples of the aromatic groups that are useful herein include the aromatic groups derived from benzene, naphthalene, and anthracene, preferably benzene. Each of these various aromatic groups may also be substituted by various substituents, including hydrocarbyl substituents.

The aromatic amine can be an amine comprising two aromatic moieties linked by an —O— group. An example of such an amine is phenoxyphenylamine, also known as phenoxyaniline or aminophenyl phenyl ether, which can be represented by and its various positional isomers (4-phenoxy, 3-phenoxy, and 2-phenoxy-aniline). Either or both of the aromatic groups can bear substituents, including hydrocarbyl, amino, halo, sulfoxy, hydroxy, nitro, carboxy, and alkoxy substituents. The amine nitrogen can be a primary amine nitrogen, as shown, or it can be secondary, that is, bearing a further substituent such as hydrocarbyl, preferably short chain alkyl such as methyl. In one embodiment, the aromatic amine is the unsubstituted material shown above.

The aromatic amine can be an amine comprising two aromatic moieties linked by an —N═N— group. i.e., an azo group. These materials are described in greater detail in U.S. Pat. No. 5,409,623, which descriptions are incorporated herein by reference. In one embodiment the azo-linked aromatic amine is represented by the formula that is 4-(4-nitrophenylazo)aniline, as well as positional isomers thereof. The material shown is commercially available as a dye known as Disperse Orange 3.

The aromatic amine can be an amine comprising two aromatic moieties linked by a —C(O)NR— group, that is an amide linkage, where R is hydrogen or hydrocarbyl. Each group may be substituted as described above for the oxygen-linked and the azo-linked amines. In one embodiment this amine is represented by the structure and positional isomers thereof; wherein each of R₁ and R₂ is independently H, —CH₃, —OCH₃, or —OC₂H₅. Likewise, the orientation of the linking amido group can be reversed, to —NR—C(O)—.

In certain embodiments, both R₁ and R₂, can be hydrogen, in which case the amine is p-amino benzanilide. When R₁ is methoxy and R₂ is methyl, the material is a commercially available dye known as Fast Violet B. When both R₁ and R₂ are both methoxy, the material is a commercially available dye known as Fast Blue RR. When both R₁ and R₂ are ethoxy, the material is a commercially available dye known as Fast Blue BB. In another embodiment, the amine can be 4-aminoacetanilide.

In one embodiment aromatic amine can be an amine comprising two aromatic moieties linked by a —C(O)O— group. Each group may be substituted as described above for the oxygen-linked and the azo-linked amines. In one embodiment this amine is represented by the formula as well as positional isomers thereof. The material shown is phenyl-4-amino salicylate or 4-amino-2-hydroxy benzoic acid phenyl ester, which is commercially available.

The aromatic amine can be an amine comprising two aromatic moieties linked by an —SO₂— group. Each of the aromatic moieties can be substituted as described above for the oxygen-linked and the azo-linked amines. In one embodiment the linkage, in addition to —SO₂—, further contains an —NR— or specifically an —NH— group, so that the entire linkage is —SO₂NR— or —SO₂NH—. In one embodiment, this aromatic amine is represented by the structure of 4-amino-N-phenyl-benzenesulfonamide. A commercially available variation thereof is sulfamethazine, or N′-(4,6-dimethyl-2-pyri-midinyl)sulfanilamide (CAS # 57-68-1), which is believed to be represented by the structure sulfamethazine as commercially available.

The aromatic amine can be a nitro-substituted aniline, which, can, likewise, bear the substituents as described above for the oxygen-linked and the azo-linked amines. Included are the ortho-, meta-, and para-substituted isomers of nitroaniline. In one embodiment the amine is 3-nitro-aniline.

The aromatic amine can also be an aminoquinoline. Commercially available materials include 3-aminoquinoline, 5-aminoquinoline, 6-aminoquinoline, and 8-aminoquinoline and homologues such as 4-aminoquinaldine.

The aromatic amine can also be an aminobenzimidazole such as 2-aminobenzimidazole.

The aromatic amine can also be an N,N-dialkylphenylenediamine such as N,N-dimethyl-1,4-phenylenediamine.

The aromatic amine can also be a ring-substituted benzylamine, with various substituents as described above. One such benzyl amine is 2,5-dimethyoxybenzylamine.

The aromatic amine may, in general, contain one or more reactive (condensable) amino groups. A single reactive amino group is sometimes preferred. Multiple amino groups, as in the case of the above described N,N-dimethylphenylenediamines, can be useful as well, especially if they are reacted under relatively mild conditions so as to avoid excessive crosslinking or gellation of the polymer.

The above-described aromatic amines can be used alone or in combination with each other. They can also be used in combination with additional, aromatic or non-aromatic, e.g., aliphatic, amines, which, in one embodiment, comprise 1 to 8 carbon atoms. These additional amines can be included for a variety of reasons. Sometimes it may be desirable to incorporate an aliphatic amine in order to assure complete reaction of the acid functionality of the polymer, in the event that some residual acid functionality may tend to react incompletely with the relatively more bulky aromatic amine. Alternatively, the aliphatic amine may replace a portion of a more costly aromatic amine, while maintaining the majority of the performance of the aromatic amine. Aliphatic monoamines include methylamine, ethylamine, propyl amine and various higher amines. Diamines or polyamines can be used for this function, provided that, in general, they have only a single reactive amino group, that is, a primary or secondary, and preferably primary, group. Suitable examples of diamines include dimethylaminopropylamine, diethylaminopropylamine, dibutyl aminopropyl amine, dimethylaminoethyl anine, diethylaminoethyl amine, dibutyl aminoethyl amine, 1-(2-aminoethyl)piperidine, 1-(2-aminoethyl)pyrrolidone, aminoethylmorpholine, and aminopropylmorpholine. The amount of such an amine is typically a minor amount compared with the amount of the aromatic amine, that is, less than 50% of the total amine present on a weight or molar basis, although higher amounts can be used, such as 70 to 130% or 90 to 110%. Exemplary amounts include 10 to 70 as eight percent, or 15 to 50 weight percent, or 20 to 40 weight percent. Use of certain combinations of 4-phenoxyaniline with dimethylaminopropylamine within these ranges, for instance, provides particularly good performance in terms of soot suspension. In certain embodiments, the polymers may be functionalized with three or more different amines, for instance, with 3-nitroaniline, 4-(4-nitrophenylazo)aniline, and dimethylaminopropylamine.

Alternatively, amines with two or more reactive groups, especially primary groups, may be used in restricted amounts in order to provide an amount of branching or crosslinking to the polymeric composition. Suitable polyamines include ethylenediamine, diethyletriamine, propylenediamine, diaminocyclohexane, methylene-bis-cyclohexylamine, 2,7-diaminofluoroene, ortho, meta, or para-xylenediamine, ortho, meta, or para-phenylenediamine, 4,4-oxydianiline, 1,5-, 1,8-, or 2,3-diaminonaphthalene, and 2,4-diaminotoluene. It has been discovered that the soot-handling properties of the dispersant-viscosity modifiers of the present invention can be further enhanced when a minor amount of a branching or crosslinking polyamine is incorporated. The amount of incorporation, however, should be restricted to those low levels that do not lead to gel formation or insolubility of the polymer. Exemplary amounts include 1 to 15, or 3 to 10, or 7 to 9, weight percent based on the total amines used, or alternatively 0.1 to 1, or 0.2 to 0.6, or 0.3 to 0.5 weight percent based on the polymer. Suitable amounts can be calculated such that about 1 molecule of primary amine will react with one acid functionality per polymer chain, leaving the remaining acid functionality to react with the (other) aromatic amines. Alternatively, if the acid functionality is provided by a diacid such as maleic acid or anhydride, then 1 primary amine can be reacted with one maleic anhydride moiety (containing 2 acid groups) per polymer chain, thereby reacting with both acid groups by imide formation. The amount of the amine may, in certain embodiments, be a stoichiometric amount so as to react with the available carboxylic acid functionality on the polymer.

In certain embodiments of the present invention, the polymer component employed may comprise a mixture of multiple, that is, two or more, polymeric reaction products differing in amine type or in molecular weight or differing in both amine type and molecular weight. For example, a mixture of a polymer condensed with 3-nitroaniline can be used in combination with a polymer condensed with an amine comprising two aromatic moieties linked by an amide linkage. Likewise, a mixture of polymers having number average molecular weight of 50,000 and 500,000 may be employed. Such mixed molecular weight polymers may be condensation products of for instance. 3-nitroaniline or any of the other appropriate aromatic amines.

Aliphatic amine compounds which may be used include, for example, alkylated mono- and di-amines, and the like.

The reaction between the base polymer and the prescribed amine compound or polyamines is preferably conducted by heating a solution of the polymer substrate under inert conditions and then adding the amine compound to the heated solution generally with mixing to effect the reaction. It is convenient to employ an oil solution of the polymer substrate heated to 120° C. to 180° C., particularly about 120° C. to 160° C., while maintaining the solution under a nitrogen blanket. The amine compound is added to this solution, usually dropwise, or in portions if it solid, and the reaction is effected under the noted conditions.

The amine compound can be dissolved with any of a surfactant, solvent, mineral oil or synthetic oil, and is added to a mineral or synthetic lubricating oil or solvent solution containing the acylated polymer. This solution is heated with agitation under an inert gas purge at a temperature in the range of 120° to 180° C. U.S. Pat. No. 5,384,371 describes an amine-functionalization process which generally can be adapted for this application, the disclosure of which is herein incorporated by reference. The reactions are carried out conveniently in a stirred reactor under nitrogen purge.

In one preferred aspect, an acylated polymer oil solution is reacted with N-phenyl-1,4-phenylenediamines, along with ethoxylated lauryl alcohol in a reactor carried out at about 120-180° C.

Surfactants which may be used in carrying out the reaction of the acylated polymer with the amine compound(s) include but are not limited to those characterized as having (a) solubility characteristics compatible with mineral or synthetic lubricating oil, (b) boiling point and vapor pressure characteristics so as not to alter the flash point of the oil and (c) polarity suitable for solubilizing the amine(s).

A suitable class of such surfactants includes the reaction products of aliphatic and aromatic hydroxy compounds with ethylene oxide, propylene oxide or mixtures thereof. Such surfactants are commonly known as aliphatic or phenolic alkoxylates. Representative examples are SURFONICO® L-24-2, NB40, N-60, L-24-5, L-46-7 (Huntsman Chemical Company), NEODOL® 23-5 and 25-7 (Shell Chemical Company) and TERGITOL®, surfactants (Union Carbide). Preferred surfactants include those surfactants that contain a functional group, e.g., —OH, capable of reacting with the acylated polymer. Ethoxylated lauryl alcohol (C₁₂H₂₅(OCH₂CH₂)ₙOH) is particularly preferred. Ethoxylated lauryl alcohol is identified under CAS no. 9002-92-0. The ethoxylated lauryl alcohol is a processing aid and viscosity stabilizer for the final multifunctional viscosity modifier product. The ethoxylated lauryl alcohol facilitates the amine charge into the reaction mixture. It is a reaction agent ensuring that no acylated functionality is left unreacted. Any unreacted acylated functionality causes undesirable viscosity drift in finished lubrication formulations. The surfactant also modifies the viscoelastic response in the multifunctional viscosity modifier product allowing improved handling at low temperature (70 to 90° C.).

The quantity of surfactant used depends in part on its ability to solubilize the amine compound. Typically, concentrations of 5 to 40 wt. % polyamine are employed. The surfactant can also be added separately, instead of or in addition to the concentrates discussed above, such that the total amount of surfactant in the finished additive is 10 wt. % or less.

The amine-functionalized polyalkylacrylate product may have a number average molecular weight between about 50,000 to about 1,000,000, particularly between about 50,000 to about 500,000.

Product Structure:

In one non-limiting embodiment, the base polymer (I), and a functionalized polyalkylacrylate copolymer dispersant (IIa+IIb) having a number average molecular weight between about 50,000 to about 1,000,000 made with the base polymer, have the following respective structures: 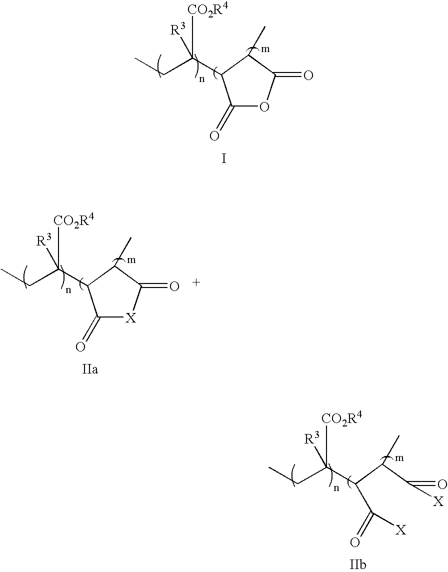
where for structures I, IIa, and IIb, m is defined as ranging from 0.1% to 20% of the value of n, wherein the sum of m and n is between 50,000 and about 1,000,000, X represents a moiety derived from the functionalizing amine bonded to the molecule through the nitrogen of an amine group, R³ and R⁴ represent the same groups as defined hereinabove. In a particular embodiment, X is derived from a functionalizing amine having the structure: R′R″(NR)ₐ NR′″R″″, wherein R, R′, R″, R′″, R″″ are independently H, alkyl, alkaryl, aralkyl, cycloalkyl, or aryl hydrocarbon and R is alkylene, aralkylene, cycloalkylene, alkarylene, or arylene, and a is 0-20. The dispersant product typically is obtained as a physical combination of compounds of structures IIa and IIb.

Color Stabilization

The acylated alkylacrylate polymer also may be color stabilized after the amination reaction, such as by reacting the acylated alkylacrylate polymer with a C₁ to C₁₂ alkyl aldehyde (e.g., nonyl aldehyde). For example, the reaction may proceed the alkyl aldehyde agent added in an amount of about 0.2 to about 0.6 wt. % under similar temperature and pressure conditions as used in the amination reaction for about 2 to about 6 hours.

Filtering

To increase the purity of the aminated, color stabilized acylated acrylated polymer product, it may be filtered by either bag or cartridge filtration or both in series.

The multi-functional polyalkylacrylate copolymer product compounds of the present invention optionally may be post-treated so as to impart additional properties necessary or desired for a specific lubricant application. Post-treatment techniques are well known in the art and include boronation, phosphorylation, and maleination.

III Lubricating Compositions

The base polymer or the multi-functional polyalkylacrylate copolymer products, or combinations thereof of the present invention may be beneficially used directly, or alternatively as pre-diluted in base oil in concentrate form, as unique additives for lubricants. The base polymer and multi-functional polymer products of the present invention find utility in lubricating oil compositions which employ base oil in which the additives are dissolved or dispersed in amount sufficient to provide the desired functionality. Such base oils may be natural, synthetic or mixtures thereof. Base oils suitable for use include those described, for example, in U.S. Pat. Nos. 6,255,261 B1 and 6,107,257, which descriptions are incorporated herein by reference.

Base oils suitable for use in preparing the lubricating oil compositions of the present invention include those conventionally employed as crankcase lubricating oils for spark-ignited and compression-ignited internal combustion engines, such as automobile and truck engines, marine and railroad diesel engines, and the like. The internal combustion engines which can be advantageously lubricated with crankcase lubricating oils containing the unique VI improver additives set forth herein include gasoline, gasohol, and diesel fuel powered engines. The diesel engines that can be beneficially lubricated include, but are not limited to, heavy duty diesel engines, including those equipped with exhaust gas recirculation (EGR) systems.

Among other advantages, these additives have been observed in performance tests to have good thickening efficiency, low temperature properties, dispersancy, and antioxidancy properties.

Advantageous results are also achieved by employing the additive mixtures of the present invention in base oils conventionally employed in and/or adapted for use as power transmitting fluids, heavy duty hydraulic fluids, power steering fluids and the like. Gear lubricants, industrial oils, pump oils and other lubricating oil compositions can also benefit from the incorporation therein of the additive mixtures of the present invention.

The finished lubricating oil composition may include other additives in addition to the copolymer of the present invention. For instance, these lubricating oil formulations may contain additional additives that will supply the characteristics that are required in the formulations. Among these types of additives are included additional viscosity index improvers, antioxidants, corrosion inhibitors, detergents, dispersats pour point depressants, antiwear agents; antifoaming agents, demulsifiers, extreme pressure agents, and friction modifiers.

In the preparation of lubricating oil formulations it is common practice to introduce the additives in the form of 10 to 80 wt. % active ingredient concentrates in hydrocarbon oil, e.g. mineral lubricating oil, or other suitable solvent.

Usually these concentrates may be diluted with 3 to 100, e.g., 5 to 40, parts by weight of lubricating oil per part by weight of the additive package in forming finished lubricants, e.g. crankcase motor oils. The purpose of concentrates, of course, is to make the handling of the various materials less difficult and awkward as well as to facilitate solution or dispersion in the final blend. Thus, the total amount of base polymer and/or multi-functional polyalkylacrylate copolymer would usually be employed in the form of a 10 to 50 wt. % concentrate, for example, in a lubricating oil fraction. In one embodiment, the total amount of the base polymer and/or multi-functional polyalkylacrylate copolymer dispersant viscosity improver in a finished lubricating oil is from about 0.1 weight percent to about 20 weight percent, particularly about 1 weight percent to about 5.0 weight percent, and more particularly about 0.5 weight percent to about 2.5 weight percent.

The base polymer and/or multi-functional polyalkylacrylate copolymers of the present invention will generally be used in admixture with a lube oil base stock, comprising an oil of lubricating viscosity, including natural lubricating oils, synthetic lubricating oils and mixtures thereof. Natural oils include animal oils and vegetable oils (e.g., castor, lard oil), liquid petroleum oils and hydrorefined, solvent-treated or acid-treated mineral lubricating oils of the paraffinic, naphthenic and mixed paraffinic-naphthenic types. Oils of lubricating viscosity derived from coal or shale are also useful base oils. The synthetic lubricating oils used in this invention include one of any number of commonly used synthetic hydrocarbon oils, which include, but are not limited to, poly-alpha-olefins, alkylated aromatics, alkylene oxide polymers, copolymers, terpolymer, interpolymers and derivatives thereof here the terminal hydroxyl groups have been modified by esterification, esterification etc, esters of dicarboxylic acids and silicon-based oils.

The present invention is further directed to a method of extending lubricant drain intervals in a vehicle is contemplated. Said method comprises adding to and operating in the crankcase of the vehicle the lubricating oil composition described above.

The following examples illustrate the preparation and use of novel polymers of the present invention. All amounts, percentages, parts, and ratios are by weight unless indicated otherwise.

### EXAMPLES

Acylated alkyl methacrylate copolymers were initially prepared in the following manner. Butyl methacrylate (“BMA”, MW=142.2), lauryl methacrylate (“LMA”, MW=262.2), and cetyl methacrylate (“CMA”, MW=327.6), were combined with maleic anhydride (“MA”, MW=98.06), lauryl mercaptan (“LSH”) and process oil were charged to a two liter reaction vessel equipped with nitrogen atmosphere and two mixing impellers rotated at 300 rpm during the reaction. The reaction mixture is preheated to about 85° C. and then azoisobutyronitrile (ABN) is added. The reaction was allowed to proceed for about 4 hours at about 79-85° C. followed by 1 hr at about 100° C. In some cases additional oil may be added at this stage to make the product pour easily. Unreacted maleic anhydride and free radical initiator were removed by heating the reaction mass to about 120° C., and applying a vacuum. The weight ratios of the reactant during polymerization and the molecular weights of the resulting acylated copolymers thus obtained are indicated in Table 1.

TABLE 1

| | % AIBN | % LSH | % MA | % BMA | % LMA | % CMA | M_{w} | Mₙ |
|---|---|---|---|---|---|---|---|---|
| Example 1 | 0.1 | 0.12 | 5.00 | 11.0 | 57.0 | 0.3 | 199330 | 86003 |
| Example 2 | 0.1 | 0.16 | 5.00 | 11.0 | 57.0 | 0.3 | 150602 | 70325 |
| Example 3 | 0.1 | 0.16 | 5.00 | 11.0 | 57.0 | 0.3 | 142055 | 66834 |
| Example 4 | 0.09 | 0.44 | 1.00 | 12.0 | 60.0 | 0.3 | 53439 | 32068 |
| Example 5 | 0.1 | 0.09 | 5.00 | 11.0 | 57.0 | 0.3 | 281162 | 107179 |
| Example 6 | 0.04 | 0.04 | 4.42 | 9.73 | 50.47 | 0.3 | 578520 | 195858 |

The acylated alkyl methacrylates thus obtained were then further reacted with various polyamines.

### Example 7

The acylated alkyl methacrylate copolymer of Example 5 was mixed with process oil at a temperature of 135° C. with mechanical stirring while the mixture was maintained under a nitrogen blanket. After the copolymer was dissolved, a mixture of n-phenyl-p-phenylenediamine (“NPPDA”, MW=184.0) and ethoxylated lauryl alcohol (“ELA,” SURFONIC® L24-2, Huntsman Chemical Company) were added and the resulting reaction mixture was maintained at between 160 to 170° C. under a nitrogen atmosphere with mechanical stirring for about 3 hrs. The resulting reaction mixture containing the multifunctionalized polymer reaction product was filtered. % N=0.36.

### Example 8

310 g of the acylated alkyl methacrylate copolymer of Example 3 was mixed with 77.4 g of process oil at a temperature of 140° C. with mechanical stirring while the mixture was maintained under a nitrogen blanket. After the copolymer was dissolved, a mixture of 17.05 g of n-phenyl-p-phenylenediamine (“NPPDA”, MW=184.0) and 8.54 g of ethoxylated lauryl alcohol (“ELA,” SURFONIC® L24-2, Huntsman Chemical Company) were added and the resulting reaction mixture was maintained at between 140° C. under a nitrogen atmosphere with mechanical stirring for about 6 hrs. The resulting reaction mixture was then vacuum stripped. % N=0.65

### Example 9

104 g of the acylated alkyl methacrylate copolymer of Example 2 and 452 g process oil were charged to a reaction vessel equipped with nitrogen atmosphere. The mixture was heated to about 160° C. and a total of 3.0 g of 4,4′-diaminodiphenylamine was added in 3 equal portions over 6 hr period. The reaction mixture was held at 160° C. for additional 6 hrs and then filtered hot. % N=0.08.

### Example 10

168.8 g of the acylated alkyl methacrylate copolymer of Example 6 was mixed with 610.9 g of process oil at a temperature of 140° C. with mechanical stirring while the mixture was maintained under a nitrogen blanket. After the copolymer was dissolved, a mixture of 7.72 g of n-phenyl-p-phenylenediamine (“NPPDA”, MW=184.0) and 8.54 g of ethoxylated lauryl alcohol (“ELA,” SURFONIC® L24-2, Huntsman Chemical Company) were added and the resulting reaction mixture was maintained at between 140° C. under a nitrogen atmosphere with mechanical stinting for about 8 hrs. The resulting reaction mixture was then vacuum stripped and filtered over Celite (% N=0.19).

### Example 11

The multifunctionalized polymer reaction product of Example 7 was blended into a heavy duty diesel 15 W40 PC-10 prototype formulation. This formulation contained 6.67 wt. % of the multifunctionalized polymer reaction product of Example 7 with 5.9 wt. % of a conventional OCP viscosity index improver. As a comparison oil, a Comparative Example 1 was formulated using the same type of base oil except containing 7.6 wt. % of the same conventional OCP VI improver. The resulting blend viscometrics are presented in Table 2. The film formation properties of these lubricating fluids were determined utilizing a High Frequency Reciprocating Rig (HFRR).

TABLE 2

| 15 W40 | KV100 | CCS (−20 C.) |
|---|---|---|
| Oil Blend Example 1 | 14.05 | 5659 |
| Comparative Example 1 | 13.55 | 5904 |

The film formation properties of lubricating fluids can be measured using a High Frequency Reciprocating Rig (HFRR) (see SAE 2002-01-2793 “Film Formation Properties of Polymers in the Presence of Abrasive Contaminants” by Mark T. Devlin et al.). In this test a steel ball oscillates across a steel disk, which is immersed in lubricant. An electrical current runs through the ball and disk. When a boundary film is formed the ball and disk are separated and the current running between the ball and disk is reduced and recorded as a percent resistance. The higher the percent resistance the more tenacious the boundary film.

For the HFRR film results presented here in Table 3, different amounts of carbon black are added to the fluids and 1-2 mL of the contaminated fluids are placed in the HFRR cell. During the test, the ball is oscillated across the disk at a frequency of 20 Hz over a 1 mm path. A load of 0.1 N is applied between the ball and the disk during the test which lasts for 10 minutes. The formation of boundary film is measured throughout the 10 minute test and the average film measurement (percent resistance) is reported.

TABLE 3

| | Comparative Example 1 | Oil Blend Example 1 |
|---|---|---|
| % Carbon Black | % Film HFRR | % Film HFRR |
| 0.0 | 87 | 91 |
| 2.0 | 63 | 89 |
| 5.0 | 37 | 60 |
| 8.0 | 12 | 50 |

When a boundary film is formed the ball and disk are separated and the current running between the ball and disk is reduced and recorded as a percent resistance. The higher the percent resistance the more tenacious the boundary film.

While the invention has been particularly described with specific reference to particular process and product embodiments, it will be appreciated that various alterations, modifications and adaptations may be based on the present disclosure, and are intended to be within the spirit and scope of the present invention as defined by the following claims.

1-24. (canceled)

25. A method of making a copolymer VI modifier comprising:
reacting i) a first set of monomers comprising alkylacrylates comprising three different subgroups including a first subgroup of alkyl acrylates wherein the alkyl group has 1 to 4 carbon atoms, a second subgroup thereof wherein the alkyl group has 8 to 16 carbon atoms, and a third subgroup wherein the alkyl group has 17 to 30 carbon atoms, with ii) a second monomer comprising an olefinic carboxylic acylating agent under conditions effective for free radical polymerization of the first and second monomers to provide a base polymer comprising an acylated alkylacrylate copolymer having a number average molecular weight between about 50,000 and 1,000,000; and, optionally,
reacting the base polymer with an amine compound to provide a multi-functional polymer viscosity modifier.

26. The method of claim 25, wherein the base polymer has a Mw of about 100,000 to about 1,000,000.

27. The method of claim 25, wherein the reacting of the base polymer with an amine compound is performed in a temperature range of about 120° C. to about 180° C.

28. The method of claim 25, wherein the multi-functional polymer viscosity modifier comprises a combination of compounds having structures IIa and IIb comprising: 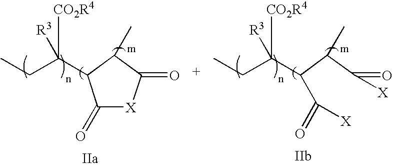
where for structures IIa and IIb, m is defined as ranging from 0.1% to 20% of the value of n, wherein the sum of m and n is between 50,000 and about 1,000,000, X represents a moiety derived from the functionalizing amine bonded to the molecule through the nitrogen of an amine group, R³ is hydrogen or a C1-C5 alkyl group, and R⁴ is a non-substituted or substituted C1-C30 alkyl group with the proviso that R⁴ is selected effective to provide said first, second and third subgroups of alkyacrylate monomers in said molar ratio.

29. The method of claim 25, wherein the gravimetric ratio of the first, second and third subgroups of alkylacrylate monomers ranges from about 5:95:0.05 to about 35:55:10, respectively.

30. The method of claim 29, wherein the alkylacrylates have the general structure: 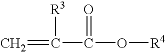
where R³ is hydrogen or a C1-C5 alkyl group, and R⁴ is a non-substituted or substituted C1-C30 alkyl group with the proviso that R⁴ is selected effective to provide said first, second and third subgroups of alkyacrylate monomers in said molar ratio.

31. The method of claim 30, wherein R³ is methyl.

31. The method of claim 25, wherein the second monomer comprises an unsaturated dicarboxylic acid anhydride or corresponding acid or ester thereof.

32. The method of claim 25, wherein the second monomer is selected from the group consisting of maleic anhydride, itaconic anhydride, halomaleic anhydride, alkylmaleic anhydride, maleic acid fumaric acid, acrylate anhydride, methacrylate anhydride, and combinations and derivatives thereof.

33. The method of claim 25, wherein the first monomer comprises methacrylate and the second monomer comprises maleic anhydride.

34. The method of claim 33, wherein the base polymer may comprise monomeric units derived from about 99.9 to about 80 weight percent of said first set of alkylacrylate monomers and about 0.1 to about 20 weight percent olefinic acylating agent monomers.

35. The method of claim 34, wherein the base polymer has a number average molecular weight between about 50,000 to about 500,000.

36. The method of claim 34, wherein the base polymer has a weighted average molecular weight between about 200,000 to about 1,000,000.

37. The method of claim 25, wherein the amine compound is selected from the group consisting of an aromatic amine and an aliphatic amine and combinations thereof.

38. The additive reaction product of claim 25, wherein the amine compound is selected from N-phenyl phenylene diamine and 4,4-diamino diphenylene amine.

39. The method of claim 25, wherein the amine compound comprises a diamine or monoamine.

40. The method of claim 25, wherein said multi-functional polymer viscosity modifier has a number average molecular weight between about 50,000 to about 1,000,000.
